(19) United States
(12) Patent Application Publication
(10) Pub. No.: US 2003/0156720 A1
(43) Pub. Date: Aug. 21, 2003

(54) Scrambler with scramble process bypass capability and descrambler with descramble process bypass capability

(75) Inventor: Masahiko Ishiwaki, Hyogo (JP)

Correspondence Address: McDERMONT, WILL & EMERY, 600 13th Street, N.W., Washington, DC, 20005-3096, US

(73) Assignee: Mitsubishi Denki Kabushiki Kaisha

(21) Appl. No.: 10/224,563

(22) Filed: Aug. 21, 2002

(30) Foreign Application Priority Data
Feb. 18, 2002 (JP) 2002-040097(P)

(51) Int. Cl. H04L 9/00

(52) U.S. Cl. 380/268

(57) ABSTRACT

A scrambler includes m serial-connected registers with reset terminals, m exclusive OR gates, and m−1 switches turned on/off according to a generating polynomial. Transmission data is input to the first exclusive OR gate. The output of the first exclusive OR gate is input to the first register. The output of the i-th register is input to the (i+1)th exclusive OR gate via the i-th switch. The output of the (i+1)th exclusive OR gate is input to the i-th exclusive OR gate. The output of the m-th register is input to the m-th exclusive OR gate. In a bypass mode of transmission data, the m registers are reset. Since reception data is directly output from the first exclusive OR gate in the bypass mode of transmission data, it is possible to confirm whether data prior to the scramble process is correct or not.

### BACKGROUND OF THE INVENTION

1. Field of the Invention

The present invention relates to a scrambler that scrambles data using a generating polynomial and a descrambler that descrambles data thereof. Particularly, the present invention relates to a scrambler that can bypass a scramble process and a descrambler that can bypass a descramble process.

2. Description of the Background Art

Recently, the technique of scrambling data is widely employed in various fields. The technique of scrambling data using a generating polynomial will be described hereinafter.

FIG. 1 shows a structure of a conventional scrambler that scrambles data in series and a conventional descrambler that descrambles such data. The scrambler includes exclusive OR (abbreviated as XOR hereinafter) gates 30-1˜30-m, switches 31-1˜31-m−1, and flip-flops (abbreviated as F/F hereinafter) 32-1˜32-m connected in series. The descrambler includes F/Fs 34-1˜34-m connected in series, switches 35-1˜35-m−1, and XOR gates 36-1˜36-m. F/Fs 32-1˜32-m and F/Fs 34-1˜34-m sequentially shift the output of the F/F of the preceding stage in synchronization with the clock.

At the scrambler side, when switches 31-1˜31-m−1 are off, XOR gates 30-2˜30-m connected thereto directly output the data from the XOR gate of the preceding stage or F/F 32-m. When switches 31-1˜31-m−1 are on, XOR gates 30-2˜30-m connected thereto take the exclusive OR of the data output from the XOR gate of the preceding stage or F/F 32-m and the data of F/Fs 32-1˜32-m−1 input via switches 31-1˜31-m−1.

XOR gate 30-1 takes the exclusive OR of the transmission data and data δT (t) output from XOR gate 30-2 and provides the operated result sequentially to a transmission line 33. For example, when the generating polynomial is x^{m}+x²+1, switch 31-2 connected to the output of F/F 32-2 is turned on whereas all the other switches are turned off. As a result, data δT (t) output from XOR gate 30-2 is the operational result of exclusive OR between the data output from F/F 32-m and the data output from F/F 32-2.

At the descrambler side, when switches 35-1˜35-m−1 are off, XOR gates 36-2˜36-m connected thereto directly output the data from the XOR gate of the preceding stage or the data from F/F 34-m. When switches 35-1˜35-m−1 are on, XOR gates 36-2˜36-m connected thereto take the exclusive OR between the data output from the XOR gate of the preceding stage or from F/F 34-m and the data of F/Fs 34-1˜34-m−1 input via switches 35-1˜35-m−1.

XOR gate 36-1 takes the exclusive OR of the data received via transmission line 33 and data δT (t) output from XOR gate 36-2 to sequentially provide the operational result as the received data. For example, when the generating polynomial is x^{m}+x²+1, switch 35-2 connected to the output of F/F 34-2 is turned on whereas all the other switches are turned off. As a result, data δT (t) output from XOR gate 36-2 becomes the exclusive OR between the data output from F/F 34-m and the data output from F/F 34-2.

FIG. 2 shows a structure of a conventional scrambler that scrambles data in parallel and a conventional descrambler that scrambles such data. The scrambler includes XOR gates 40-1˜40-64, and F/Fs 41-1˜41-64. This scrambler scrambles 64-bit data using a generating polynomial set forth below. It is to be noted that equation (1) is only a way of example of a generating polynomial. When a generating polynomial differing from the generating polynomial of equation (1) is to be employed, the value of a F/F corresponding to the generating polynomial is input to XOR gates 40-1˜40-64.

S58=D58+S19+S0 (1)

Equation (1) can be expressed by the following equations.

S128=D128+S89+S70

S127=D127+S88+S69

. . .

S66=D66+S27+S8

S65=D65+S26+S7 (2)

For example, XOR gate 40-1 takes the exclusive OR of transmission data D65, data S7 held in F/F 41-7 and data S26 held in F/F 41-26 to provide the operated result as scramble data S65. XOR gate 40-63 takes the exclusive OR of transmission data D127, data S69 output from XOR gate 40-5, and data S88 output from XOR gate 40-24 to provide the operated result as scramble data S127. The output scramble data S65-S128 are held in F/Fs 41-1˜41-64. These stored values are used when the next 64-bit data is scrambled.

The descrambler includes F/Fs 42-1˜42-64 and XOR gates 43-1˜43-64. This descrambler descrambles 64-bit data using the polynomial of equation (2).

In this descrambler, scramble data S65˜S128 are held in F/Fs 42-1˜42-64 as data S1-S64. These stored values are used when 64-bit data is descrambled. For example, XOR gate 43-1 takes the exclusive OR of scramble data S65, data S7 held in F/F 42-7 and data S26 held in F/F 42-26 to provide the operated result as reception data D65. XOR gate 43-63 take the exclusive OR of scramble data S127, data S69 input to XOR gate 43-5, and data S88 input to XOR gate 43-24 to provide the operated result as reception data D127.

Although transmission data is sequentially scrambled and output onto the transmission line in the above-described scrambler, the descrambler can properly restore reception data after the bit data are stored in all the F/Fs. However, there was a problem that it is difficult to confirm whether the data prior to the scramble process is the proper data or not even if the transmission line is confirmed since the value of scrambled data cannot easily be estimated.

When there is a data error between the transmission line and the descrambler, there was a problem that it is difficult to confirm what kind of data error has occurred even if the reception data is identified since data after the descramble process cannot be estimated.

### SUMMARY OF THE INVENTION

An object of the present invention is to provide a scrambler and a descrambler that can bypass data.

Another object of the present invention is to provide a scrambler and a descrambler that can have power consumption reduced.

According to an aspect of the present invention, a scrambler includes m registers connected in series, m XOR gates, and m−1 switches turned on/off according to a generating polynomial, where m is an integer of at least 2, and i is an arbitrary integer of at least 1 and not more than m−1. Transmission data is input to the first XOR gate, and the output of the first XOR gate is input to the first register. The output of the i-th register is input to the (i+1)th XOR gate via the i-th switch. The output of the (i+1)th XOR gate is input to the i-th XOR gate. The output of the m-th register is input to the m-th XOR gate. When the i-th switch is on, the (i+1)th XOR gate carries out an exclusive OR operation. When the i-th switch is off, the (i+1)th exclusive OR gate directly outputs the value of the terminal that is not connected to the switch. In a transmission data bypass mode, a low level is applied to the terminal of the first XOR gate to which transmission data is not input.

Since a low level is applied to the terminal of the first XOR gate to which transmission data is not input in a transmission data bypass mode, the transmission data is directly output from the first XOR gate. It is therefore possible to confirm whether the data prior to the scramble process is correct or not.

According to another aspect of the present invention, a scrambler carrying out a process in parallel includes m registers and m XOR gates, where m is an integer of at least 2. The m registers hold scrambled data. The m XOR gates respectively have each bit of the transmission data input, and an output of a register selectively input according to a generating polynomial. In a transmission data bypass mode, the outputs of the m registers are driven to a low level.

Since the outputs of the m registers are driven to a low level in a transmission data bypass mode, the transmission data is directly output from the m XOR gates. Therefore, it is possible to confirm whether the data prior to the scramble process is correct or not.

According to a further aspect of the present invention, a descrambler includes m registers connected in series, m XOR gates, and m−1 switches turned on/off according to a generating polynomial, where m is an integer of at least 2 and i is an arbitrary integer of at least 1 and not more than m−1. The scrambled data is input to the first register and the first XOR gate. The output of the i-th register is input to the (i+1)th XOR gate via the i-th switch. The output of the (i+1)th XOR gate is input to the i-th XOR gate. The output of the m-th register is input to the m-th XOR gate. When the i-th switch is on, the (i+1)th XOR gate carries out an exclusive OR operation. When the i-th switch is off, the (i+1)th XOR gate directly outputs the value of the terminal that is not connected to the switch. In a scrambled data bypass mode, the terminal of the first XOR gate to which scrambled data is not input is driven to a low level.

Since the terminal of the first XOR gate to which scrambled data is not input is driven to a low level when in a scrambled data bypass mode, the scrambled data is directly output from the first XOR gate. Therefore, it is possible to confirm what kind of error has occurred between the transmission line and the descrambler.

According to still another aspect of the present invention, a descrambler carrying out a process in parallel includes m registers, and m XOR gates, where m is an integer of at least 2. The m registers hold the previous scrambled data. The m XOR gates respectively have each bit of the scrambled data input, and an output of a register selectively input according to a generating polynomial. When in a scrambled data bypass mode, the outputs of the m registers are driven to a low level.

Since the outputs of the m registers are driven to a low level when in a scrambled data bypass mode, scrambled data is directly output from the m XOR gates. It is therefore possible to confirm what kind of error has occurred between the transmission path and the descrambler.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 shows a structure of a conventional scrambler that scrambles data in series and a conventional descrambler thereof.

FIG. 2 shows a structure of a conventional scrambler that scrambles data in parallel and a conventional descrambler thereof.

FIG. 3 shows a structure of a scrambler and a descrambler according to a first embodiment of the present invention.

FIG. 4 shows a structure of a scrambler and a descrambler according to a second embodiment of the present invention.

FIG. 5 shows a structure of a scrambler and a descrambler according to a third embodiment of the present invention.

FIG. 6 shows a structure of a scrambler and a descrambler according to a fourth embodiment of the present invention.

### DESCRIPTION OF THE PREFERRED EMBODIMENTS

First Embodiment

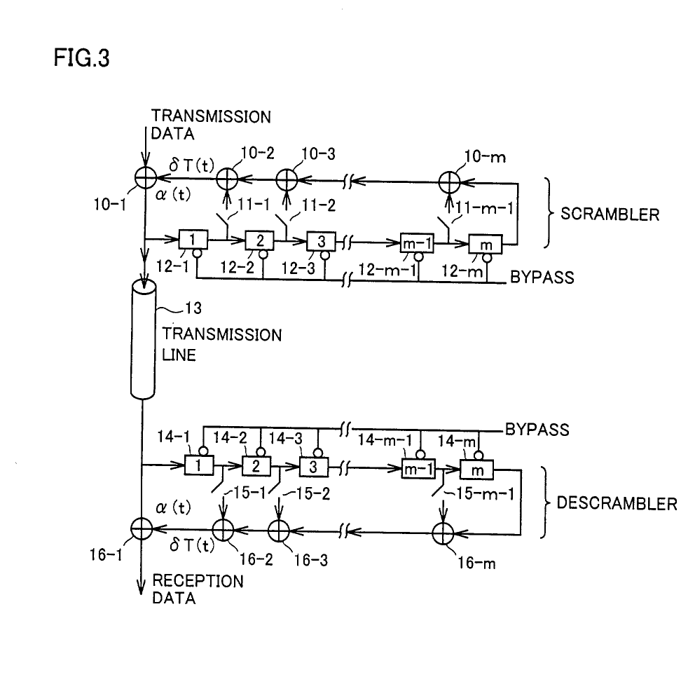

FIG. 3 shows a structure of a scrambler and a descrambler according to a first embodiment of the present invention. The scrambler includes XOR gates 10-1˜10-m, switches 11-1˜11-m−1, and serial-connected F/Fs 12-1˜12-m having reset terminals. The descrambler includes serial-connected F/Fs 14-1˜14-m having reset terminals, switches 15-1˜15-m−1, and XOR gates 16-1˜16-m. F/Fs 12-1˜12-m and F/Fs 14-1˜14-m sequentially shift the output of the preceding-stage F/F in synchronization with a clock. Although a F/F is employed as a register here, a circuit that can retain a value such as a latch can be used instead.

The operation of the scrambler will be described here. When switches 11-1˜11-m−1 are off, XOR gates 10-2˜10-m connected thereto directly output the data from the XOR gate of the preceding stage or from F/F 12-m. When switches 11-1-˜11-m−1 are on, XOR gates 10-2˜10-m connected thereto take the exclusive OR of the data output from the XOR gate of the preceding stage or F/F 12-m and the data of F/Fs 12-1˜12-m−1 input via switches 11-1˜11-m−1 to output the operated result.

XOR gate 10-1 takes the exclusive OR of transmission data, and data δT (t) output from XOR gate 10-2 to sequentially provide the operational result onto a transmission line 13. For example, when the generating polynomial is x^{m}+x²+1, switch 11-2 connected to the output of F/F 12-2 is turned on, and all the other switches are turned off. As a result, δT (t) output from XOR gate 10-2 becomes the data that is the exclusive OR of the data output from F/F 12-m and the data output from F/F 12-2.

A signal designating bypass is input to the reset terminals of F/Fs 12-1˜12-m. When the signal designating bypass is at an enable state (low level), F/Fs 12-1˜12-m are reset, whereby respective F/Fs 12-1˜12-m output a low level. Here, the XOR gate connected to a switch that is on has a low level input via that switch to directly output the data of the XOR gate of the preceding stage. The XOR gate connected to the switch that is off directly outputs the data of the XOR gate of the preceding stage. Therefore, XOR gate 10-2 outputs the data of F/F 12-m, i.e., a low level. As a result, XOR gate 10-1 outputs the transmission data as it is.

The operation of the descrambler will be described hereinafter. When switches 15-1˜15-m−1 are off, XOR gates 16-2˜16-m connected thereto directly output the data from the XOR gate of the preceding stage or from F/F 14-m. When switches 15-1˜15-m−1 are on, XOR gates 16-2˜16-m connected thereto take the exclusive OR of the data output from the XOR gate of the preceding stage or from F/F 14-m, and the data of F/Fs 14-1˜14-m−1 input via switches 15-1˜15-m−1.

XOR gate 16-1 takes the exclusive OR of data received via transmission line 13 and data δT (t) output from XOR gate 16-2 to sequentially output the operational result as reception data. For example, when the generating polynomial is x^{m}+x²+1, switch 15-2 connected to the output of F/F 14-2 is turned on, whereas all the other switches are turned off. As a result, data δT (t) output from XOR gate 16-2 becomes the exclusive OR of data output from F/F 14-m and data output from F/F 14-2.

A signal designating bypass is input to the reset terminals of F/Fs 14-1˜14-m. When the signal designating bypass is at an enable state (low level), F/Fs 14-1˜14-m are reset, whereby respective F/Fs 14-1˜14-m output a low level. Here, the XOR gate connected to the switch that is on has a low level applied via the switch thereof. Therefore, data of the XOR gate of the preceding stage is directly output. The XOR gate connected to the switch that is off directly outputs the data of the XOR gate of the preceding stage. Therefore, XOR gate 16-2 outputs the data of F/F 14-m, i.e., outputs a low level. As a result, XOR gate 16-1 outputs the scrambled data as it is.

It is to be noted that the correct data cannot be restored right after return from the bypass. However, it is not necessary to define the timing to cancel bypass strictly since the main aim is to confirm transmission/reception data in a bypass mode. Accordingly, the design of the scrambler and the descrambler is facilitated since a circuit to correctly generate the timing of a bypass signal is dispensable.

According to the scrambler and the descrambler of the present embodiment, the F/Fs connected in series have reset terminals to be all reset in a bypass mode. Therefore, the transmission data or scrambled data can be directly bypassed. It is therefore possible to confirm whether the data prior to the scrambling process is correct or not at the scrambler. Furthermore, it is possible to confirm what kind of error has occurred between the transmission line and the descrambler at the descrambler.

Since all the F/Fs are reset during the bypass process, the outputs of the F/Fs are all fixed. Therefore, power consumption of the scrambler and descrambler can be reduced.

Second Embodiment

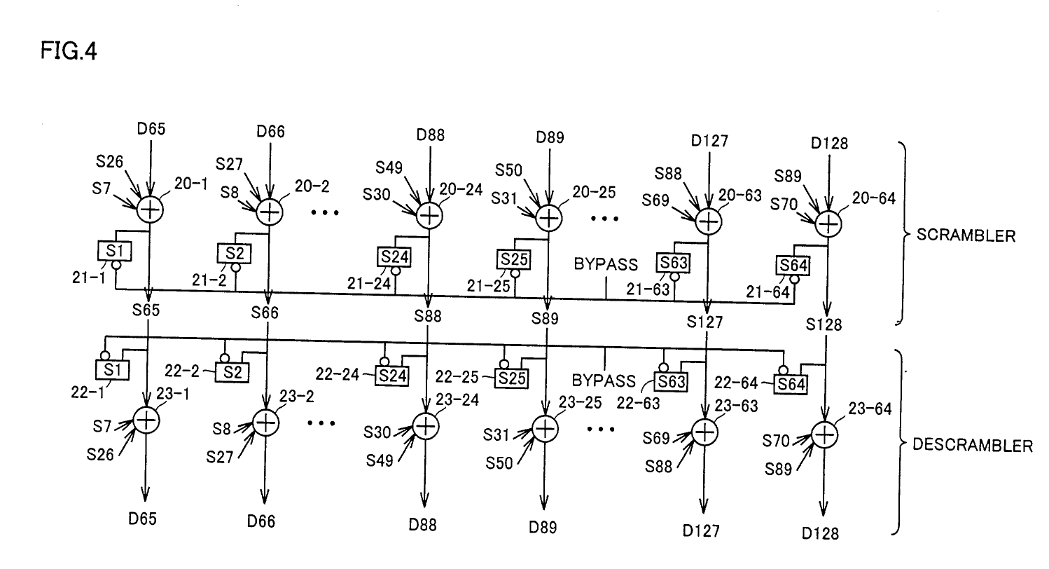

FIG. 4 shows a structure of a scrambler and a descrambler according to a second embodiment of the present invention. The scrambler includes XOR gates 20-1˜20-64, and F/Fs 21-1˜21-64 having reset terminals. This scrambler of the second embodiment scrambles 64-bit data using the generating polynomial of equation (2). Equation (2) is only a way of example of a generating polynomial. When a generating polynomial differing from the generating polynomial of equation (2) is to be employed, a F/F value corresponding to the generating polynomial is input to XOR gates 20-1˜20-64.

For example, XOR gate 20-1 takes the exclusive OR of transmission data D65, data S7 held in F/F 21-7, and data S26 held in F/F 21-26 to output the operational result as scramble data S65. XOR gate 20-63 takes the exclusive OR of transmission data D127, data S69 output from XOR gate 20-5, and data S88 output from XOR gate 20-24 to provide the operational result as scramble data S127. The outputs of scrambled data S65-S128 are held in F/Fs 21-1˜21-64 to be used when the next 64-bit data is to be scrambled.

A signal designating bypass is input to the reset terminals of F/Fs 21-1˜21-64. When the signal designating bypass is at an enable state (low level), F/Fs 21-1˜21-64 are reset, whereby each of F/Fs 21-1˜21-64 outputs a low level. As a result, XOR gates 20-1˜20-64 directly output transmission data D65-D128 as it is.

The descrambler includes F/Fs 21-1˜22-64, and XOR gates 23-1˜23-64. The descrambler of the second embodiment descrambles 64-bit data using the generating polynomial of equation (2).

In the descrambler of the second embodiment, scramble data S65-S128 are held in F/Fs 22-1˜22-64 as data S1-S64 which are used in descrambling 64-bit data. XOR gate 23-1, for example, takes the exclusive OR of scramble data S65, data S7 held in F/F 22-7, and data S26 held in F/F 22-26 to provide the operational result as reception data D65. XOR gate 23-63 takes the exclusive OR of scramble data S127, data S69 input to XOR gate 23-5, and data S88 input to XOR gate 23-24 to provide the operational result as reception data D127.

A signal designating bypass is applied to the reset terminals of F/Fs 22-1˜22-64. When the signal designating bypass is at an enable state (low level), F/Fs 22-1˜22-64 are reset, whereby each of F/Fs 22-1˜22-64 outputs a low level. As a result, each of XOR gates 23-1˜23-64 directly outputs scrambled data S65-S128, respectively.

According to the scrambler and descrambler of the present embodiment, the F/Fs include reset terminals to be all reset in a bypass process. Therefore, transmission data or scrambled data can be directly bypassed. At the scrambler side, it is possible to confirm whether the data prior to the scramble process is correct or not. Also, at the descrambler side, it is possible to confirm what kind of error has occurred between the transmission line and the descrambler.

Since all F/Fs are reset in the bypass process, the outputs of the F/Fs are fixed. It is therefore possible to reduce the power consumption of the scrambler and descrambler.

Third Embodiment

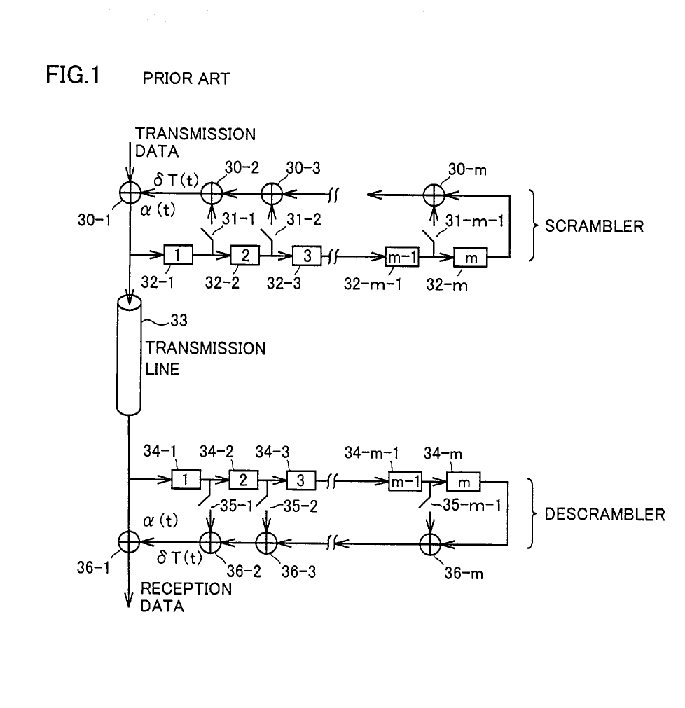

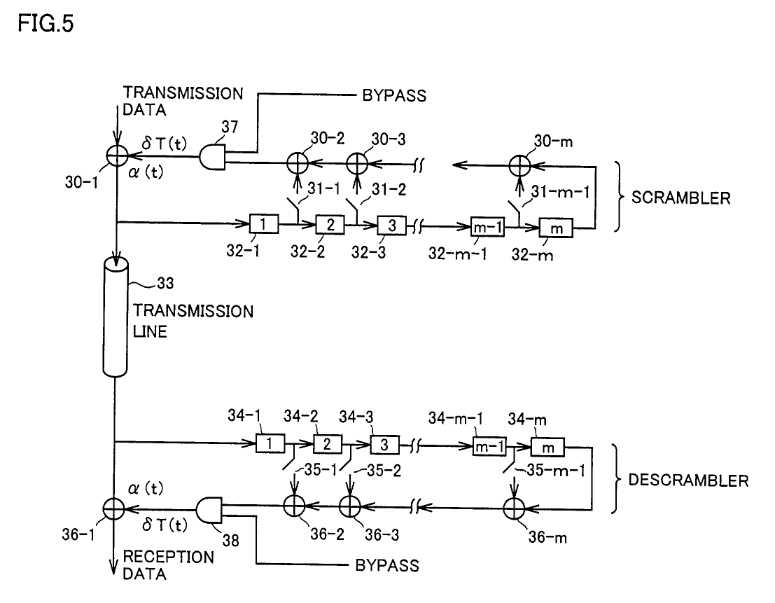

FIG. 5 shows a structure of a scrambler and a descrambler according to a third embodiment of the present invention. The scrambler of the third embodiment differs from the conventional scrambler of FIG. 1 in that an AND gate 37 is added between XOR gates 30-1 and 30-2. Furthermore, the descrambler of the third embodiment differs from the conventional descrambler of FIG. 1 in that an AND gate 38 is added between XOR gates 36-1 and 36-2. Detailed description of the similar structure and function will not be repeated here.

At the scrambler of the third embodiment, a signal designating bypass is applied to one terminal of AND gate 37. When the signal designating bypass is at an enable state (low level), the output signal of XOR gate 30-2 is masked, and AND gate 37 outputs a low level. As a result, XOR gate 30-1 directly outputs the transmission data.

At the descrambler, a signal designating bypass is applied to one terminal of AND gate 38. When the signal designating bypass is at an enable state (low level), the output signal of XOR gate 36-2 is masked, and AND gate 38 outputs a low level. As a result, XOR gate 36-1 directly outputs the scrambled data.

It is to be noted that the correct data will not be restored immediately after return from the bypass. However, it is not necessary to strictly define the bypass cancel timing since the main aim is to confirm the transmission/reception data during bypass. Thus, the designing of the scrambler and descrambler, is facilitated since a circuit that provides a proper timing of a bypass signal is dispensable.

According to the scrambler and descrambler of the third embodiment, AND gate 37 or 38 outputs a low level in a bypass mode. Therefore, the transmission data or scrambled data can directly be bypassed. At the scrambler side, it is possible to confirm whether the data prior to the scramble process is correct or not. At the descrambler side, it is possible to confirm what kind of error has occurred between the transmission line and the descrambler.

Fourth Embodiment

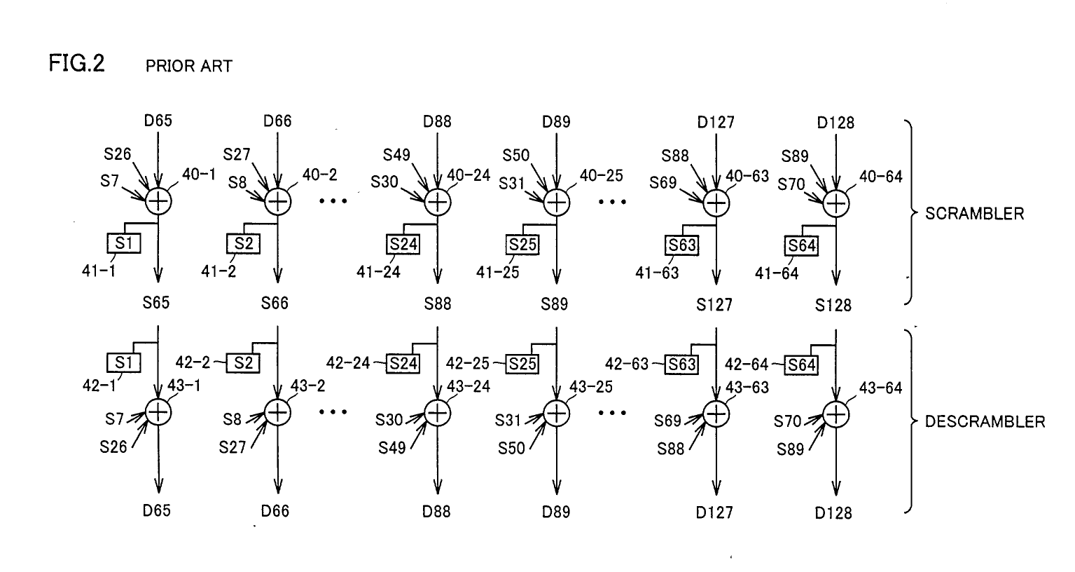

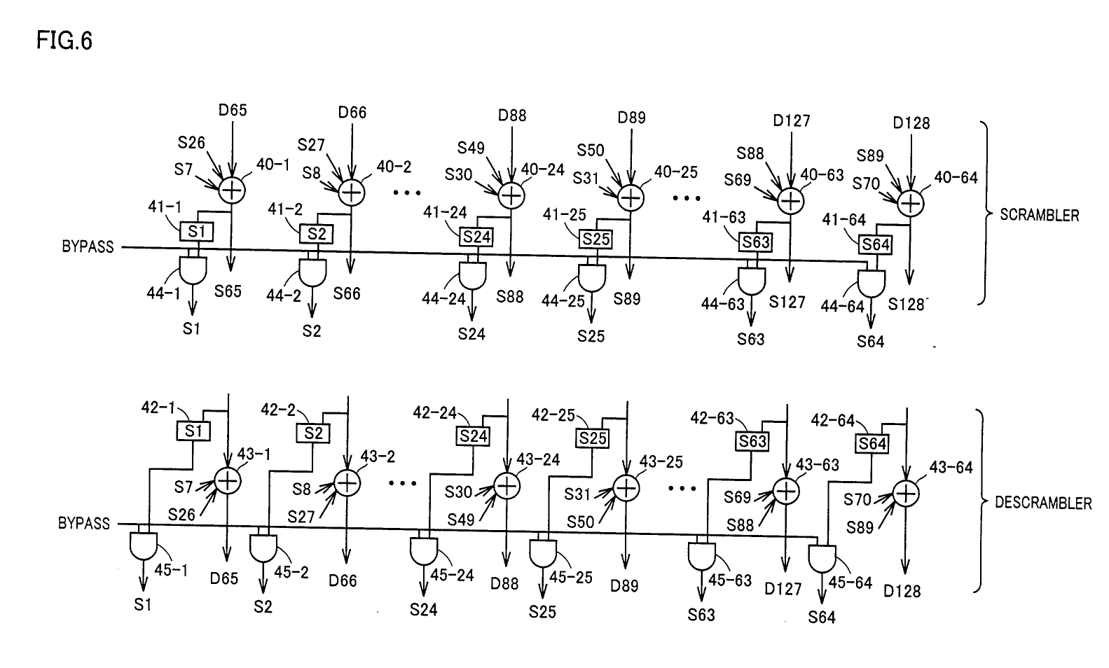

FIG. 6 shows the structure of a scrambler and a descrambler according to a fourth embodiment of the present invention. This scrambler differs from the conventional scrambler of FIG. 2 in that AND gates 44-1˜44-64 are additionally provided. AND gates 44-1˜44-64 are connected to the outputs of F/Fs 41-1˜41-6, respectively. The descrambler of the fourth embodiment differs from the conventional descrambler of FIG. 2 in that AND gates 45-1˜45-64 are additionally provided. AND gates 45-1˜45-64 are connected to the outputs of F/Fs 42-1˜42-64, respectively. Detailed description of likewise structure and function will not be repeated here.

At the scrambler of the fourth embodiment, a signal designating bypass is applied to the one terminals of AND gates 44-1˜44-64. When the signal designating bypass is at an enable state (low level), the output signals of F/Fs 41-1˜41-64 are masked, and AND gates 44-1˜44-64 output a low level. As a result, each of XOR gates 40-1˜40-64 directly outputs the transmission data.

At the descrambler, a signal designating bypass is applied to the one terminals of AND gates 45-1˜45-64. When the signal designating bypass is at an enable state (low level), the output signals of F/Fs 42-1˜42-64 are masked, and each of AND gates 45-1˜45-64 outputs a low level. As a result, XOR gates 43-1˜43-64 directly output scrambled data.

According to the scrambler and the scrambler of the fourth embodiment, AND gates 44-1˜44-64 or 45-1˜45-64 output a low level in a bypass process. Therefore, the transmission data or scrambled data can be directly bypassed. Therefore, at the scrambler side, it is possible to confirm whether the data prior to the scramble process is correct or not. Furthermore, at the descramble side, it is possible to confirm what kind of error has occurred between the transmission line and the descrambler.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A scrambler comprising:
m registers connected in series;
m exclusive OR gates; and
m−1 switches turned on/off according to a generating polynomial;
where m is an integer of at least 2 and i is an arbitrary integer of at least 1 and not more than m−1,
transmission data being input to a first exclusive OR gate,
an output of the first exclusive OR gate being input to a first register,
an output of an i-th register being input to an (i+1)th exclusive OR gate via an i-th switch,
an output of the (i+1)th exclusive OR gate being input to the i-th exclusive OR gate,
an output of an m-th register being input to an m-th exclusive OR gate, and
the (i+1)th exclusive OR gate carrying out an exclusive OR operation when the i-th switch is on, and the (i+1)th exclusive OR gate directly outputting a value of a terminal to which a switch is not connected when the i-th switch is off; and
said scrambler further comprising a circuit outputting a low level to a terminal of said first exclusive OR gate to which transmission data is not input in a transmission data bypass mode.

2. The scrambler according to claim 1, wherein said m registers includes reset terminals,
said m registers being reset in a transmission data bypass mode.

3. The scrambler according to claim 1, wherein said circuit includes an AND gate connected between said first exclusive OR gate and a second exclusive OR gate, and having one input terminal to which a signal designating bypass is input.

4. A scrambler carrying out a process in parallel, comprising:
m registers; and
m exclusive OR gates;
where m is an integer of at least 2;
said m registers holding scrambled data,
said m exclusive OR gates respectively having each bit of transmission data input, and an output of said register selectively input according to a generating polynomial; and
said scrambler further comprising a circuit driving outputs of said m registers to a low level in a transmission data bypass mode.

5. The scrambler according to claim 4, wherein said m registers includes reset terminals,
said m registers being reset when in a transmission data bypass mode.

6. The scrambler according to claim 4, wherein said circuit includes m AND gates respectively having outputs of said m registers connected, and having a signal designating bypass applied to one input terminal.

7. A descrambler comprising:
m registers connected in series;
m exclusive OR gates; and
m−1 switches turned on/off according to a generating polynomial;
where m is an integer of at least 2 and i is an arbitrary integer of at least 1 and not more than m−1,
scrambled data being input to a first register and a first exclusive OR gate,
an output of an i-th register being input to an (i+1)th exclusive OR gate via an i-th switch,
an output of the (i+1)th exclusive OR gate being input to an i-th exclusive OR gate,
an output of an m-th register being input to an m-th exclusive OR gate,
the (i+1)th exclusive OR gate carrying out an exclusive OR operation when the i-th switch is on, and the (i+1)th exclusive OR gate directly outputting a value of a terminal to which the switch is not connected when the i-th switch is off; and
said descrambler further comprising a circuit outputting a low level to one terminal of said first exclusive OR gate to which scrambled data is not input is a scrambled data bypass mode.

8. The descrambler according to claim 7, wherein said m registers includes reset terminals,
said m registers being reset in a scrambled data bypass mode.

9. The descrambler according to claim 7, wherein said circuit includes an AND gate connected between said first exclusive OR gate and a second exclusive OR gate, and having one input terminal to which a signal designating bypass is input.

10. A descrambler carrying out a process in parallel, comprising:
m registers; and
m exclusive OR gates;
where m is an integer of at least 2,
said m registers holding previous scrambled data,
said m exclusive OR gates respectively having each bit of scrambled data input, and an output of said register selectively input according to a generating polynomial; and
said descrambler further comprising a circuit driving outputs of said m registers to a low level in a scrambled data bypass mode.

11. The descrambler according to claim 10, wherein said m registers include reset terminals,
said m registers being reset in a scrambled data bypass mode.

12. The descrambler according to claim 10, wherein said circuit includes m AND gates respectively connected to outputs of said m registers, and having one input terminal to which a signal designating bypass is applied.
